(19) United States
(12) Patent Application Publication
(10) Pub. No.: US 2025/0109875 A1
(43) Pub. Date: Apr. 3, 2025

(54) BUILDING CONTROL SYSTEM AND METHOD USING ADAPTIVE ARTIFICIAL INTELLIGENCE MODEL

(71) Applicant: Tyco Fire & Security GmbH, Neuhausen am Rheinfall (CH)

(72) Inventors: Andrew J. Przybylski, Franksville, WI (US); John H. Burroughs, Wauwautosa, WI (US)

(73) Assignee: Tyco Fire & Security GmbH, Neuhausen am Rheinfall (CH)

(21) Appl. No.: 18/900,578

(22) Filed: Sep. 27, 2024

Related U.S. Application Data
(60) Provisional application No. 63/541,614, filed on Sep. 29, 2023.

(51) Int. Cl. F24F 11/63; F24F 130/10; G05B 13/02; G05B 13/04

(52) U.S. Cl. CPC F24F 11/63; G05B 13/0265; G05B 13/048; F24F 2130/10

(57) ABSTRACT

A controller for equipment that operates to affect a variable state or condition of a building including one or more processors and non-transitory computer-readable media storing instructions that, when executed by the processors, cause the processors to perform operations. The operations include performing model predictive control and proportional, integral, derivative control using adaptive artificial intelligence, performing tampering prediction using adaptive artificial intelligence, or detecting degradation using adaptive artificial intelligence.

### CROSS-REFERENCE TO RELATED PATENT APPLICATIONS

This application claims the benefit of U.S. Provisional Patent Application No. 63/541,614 filed Sep. 29, 2023, the entire contents of which is incorporated herein by reference. This application is related to U.S. patent application Ser. No. 16/513,054 filed Jul. 16, 2019, and U.S. Pat. No. 9,835,349 granted on Dec. 5, 2017, the entire contents of each are incorporated herein by reference.

### BACKGROUND

The present disclosure relates generally to control systems for a building including but not limited to adaptively trained artificial intelligence (AI) device model control systems. The present disclosure can relate to systems and methods that use an adaptively trained AI device model for model predictive control (MPC), an adaptively trained AI device model for detecting equipment tampering, an adaptively trained AI device model for detecting equipment degradation, and/or an approach to adaptively enable MPC or an AI model for proportional-integral-derivative (PID) control or other control with predictive AI.

Modeling can be used in a building management system (BMS). A BMS is, in general, a system of devices configured to control, monitor, and/or manage equipment in or around a building, buildings, or building area. A BMS can be or include, for example, a heating ventilating, or air conditioning (HVAC) system, a security system, a lighting system, a fire alerting system, any other system that is capable of managing building environments, functions or devices, and/or any combination thereof. Various control algorithms can be used to set parameters, such as, positions, (e.g., damper positions), flow, energy consumption, rates, etc., and to adjust such parameters. PID control algorithms can be used in a BMS to control various equipment and/or systems (e.g., components of HVAC systems). Various types of controllers (e.g., motor controllers, power controllers, fluid controllers, other types of HVAC controllers, lighting controllers, chemical controllers, process controllers, etc.) can use such algorithms. PID algorithms are generally not predictive and may require time to respond to changing conditions.

### SUMMARY

At least one embodiment of the present disclosure relates to a controller for equipment that operates to affect a variable state or condition of a building. The controller includes one or more processors and one or more non-transitory computer-readable media storing instructions that, when executed by the one or more processors, cause the one or more processors to perform operations. The operations include executing an artificial intelligence model trained to generate (i) a prediction of behavior of the variable state or condition in response to one or more control inputs and (ii) a confidence of the prediction. The operations also include executing a model predictive control process using the artificial intelligence model responsive to the confidence exceeding a threshold. The operations also include executing a proportional integral derivative control process responsive to the confidence being less than or equal to the threshold. The operations also include operating an actuator to affect the variable state or condition based on a result of the model predictive control process or a result of the proportional integral derivative control process.

In some embodiments, the confidence of the prediction depends on a current value of the variable state or condition.

In some embodiments, the confidence of the prediction depends on a plurality of values of the variable state or condition that satisfy a distance criterion to the current value.

In some embodiments, the artificial intelligence model includes at least one of a state-space model, a neural network model, or an autoregressive model.

In some embodiments, executing the artificial intelligence model includes generating a first prediction of the behavior and a first confidence of the first prediction using a first submodel. Executing the artificial intelligence model also includes generating a second prediction of the behavior and a second confidence of the second prediction using a second submodel. Executing the artificial intelligence model also includes outputting the first prediction responsive to the first confidence exceeding the second confidence and outputting the second prediction responsive to the first confidence being less than or equal to the second confidence.

In some embodiments, the first submodel comprises a neural network model and the second submodel comprises an autoregressive model or a state-space model.

In some embodiments, the result of the model predictive control process comprises a sequence of control actions to implement over a time period.

In some embodiments, the operations also include generating an objective function that depends on historical behavior of the variable state or condition, historical values of the actuator, and parameters of the artificial intelligence model. The operations also include performing a training process to update the parameters of the artificial intelligence model to reduce a value of the objective function.

At least one embodiment of the present disclosure relates to a controller for equipment that operates to affect a variable state or condition of a building, the controller includes one or more processors and one or more non-transitory computer-readable media storing instructions that, when executed by the one or more processors, cause the one or more processors to perform operations. The operations include generating an objective function that depends on training data and parameters of an artificial intelligence model, the training data comprising historical values of the variable state or condition and historical values of an actuator affecting the variable state or condition. The operations also include performing a training process to update the parameters of the artificial intelligence model to reduce a value of the objective function. The operations also include executing a control process using the artificial intelligence model based on a value of the variable state or condition to generate a control result. The operations also include detecting a degradation in performance of the equipment in response to determining that a change in a relationship between the value of the variable state or condition and the control result satisfies a detection criterion. The operations also include initiating an action responsive to detecting the degradation in performance of the equipment.

In some embodiments, the artificial intelligence model includes at least one of a state-space model, a neural network model, or an autoregressive model.

In some embodiments, detecting the degradation in performance of the equipment includes generating a plurality of regions of the variable state or condition. Detecting the degradation in performance of the equipment also includes calculating a first average result based on a first set of results corresponding to a first set of values of the variable state or condition within a region of the plurality of regions, the first set of values of the variable state collected during a first time period before updating the parameters. Detecting the degradation in performance of the equipment also includes calculating a second average result based on a second set of results corresponding to a second set of values of the variable state or condition within the region of the plurality of regions, the second set of values of the variable state collected during a second time period after updating the parameters. Detecting the degradation in performance of the equipment also includes calculating a difference of the first average result and the second average result.

In some embodiments, detecting the degradation in performance of the equipment also includes calculating a first standard deviation of the first set of results and a second standard deviation the second set of results, and determining if the difference is greater than a function of the second standard deviation and the first standard deviation.

In some embodiments, detecting the degradation in performance of the equipment also includes determining that the detection criterion is satisfied in response to a fraction of the plurality of regions for which the difference is greater than the function exceeds a fractional threshold.

In some embodiments, the action includes sending a notification, executing a proportional integral derivative control process, or initiating a maintenance action.

At least one embodiment of the present disclosure relates to a controller for equipment that operates to affect a variable state or condition of a building, the controller includes one or more processors and one or more non-transitory computer-readable media storing instructions that, when executed by the one or more processors, cause the one or more processors to perform operations. The operations include executing a control process using an artificial intelligence model based on a value of the variable state or condition to generate a control result. The operations also include executing an estimation process using the artificial intelligence model based on at least the value of the variable state or condition to generate an estimated state. The operations also include determining that a threat actor has modified either a setpoint of the control process or a feedback variable of the control process by detecting at least one of (i) the control result exceeding validated control bounds or (ii) a difference between the estimated state and the value of the variable state or condition satisfying a detection criterion. The operations also include initiating an action in response to determining that the threat actor has modified either the setpoint of the control process or the feedback variable of the control process.

In some embodiments, the action includes sending a notification, initiating a reset procedure, or disconnecting the controller from an external network.

In some embodiments, the estimation process comprises a Kalman filter.

In some embodiments, the validated control bounds are determined based at least on data comprising historical control results and historical values of the variable state or condition.

In some embodiments, the validated control bounds are determined based additionally on historical weather data and current weather data.

In some embodiments, initiating the action is further based on a model fit metric of the artificial intelligence model using recent values of the variable state or condition and recent values of the control result.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE FIGURES

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with an HVAC system, according to some embodiments.

FIG. 2 is a block diagram of the building and HVAC system illustrated in FIG. 1 including a controller, according to some embodiments.

FIG. 3 is a more detailed block diagram of an embodiment of the controller illustrated in FIG. 2 for use with the HVAC system of FIG. 1, according to some embodiments.

FIG. 4 is a block diagram of a model identifier for use with the controller illustrated in FIG. 3, according to some embodiments.

FIG. 5 is a block diagram of an adaptively enabled MPC system and PID control system for the controller of FIG. 2, according to some embodiments.

FIG. 6 is a block diagram of an adaptively enabled MPC system for tampering detection for the controller of FIG. 2, according to some embodiments.

FIG. 7 is a block diagram of an adaptively enabled MPC system for degradation detection for the controller of FIG. 2, according to some embodiments.

FIG. 8 is a flow of operations for providing predictive control or PID control dependent on a selection based on the confidence in a model used by the predictive control algorithm, according to some embodiments.

FIG. 9 is a flow of operations for detecting degradation of the equipment based on the output of a predictive control algorithm, according to some embodiments.

FIG. 10 is a flow of operations for detecting tampering with a controller, according to some embodiments.

### DETAILED DESCRIPTION

### Overview

Referring generally to the FIGURES, control systems and methods using adaptive artificial intelligence model provide significant advantages for a number of applications, according to some embodiments. In some embodiments, accurate predictive models for various control methods for building equipment are used with AI. One example of a model control method is MPC. Without an accurate predictive model, conventional control methods may generate control decisions that do not maintain occupant comfort and/or optimize (e.g., reduce) costs. For example, PID control systems require tuning and while schemes such as pattern recognition adaptive control (PRAC) schemes allow PID control systems to adapt over time, such PID control systems need to readapt if the system has seasonal changes. Additionally, the tuning is often conservative so that instability is prevented in extreme conditions. Conservative tuning can cause a slow response in more moderate conditions.

In some embodiments, proactive and responsive control is provided using AI. In some embodiments, AI data about the system model and its disturbances can be used with MPC control and/or PID control to more quickly respond and accurately respond to disturbances. In some embodiments, an MPC control system or another AI control system can run in parallel with an existing PID control system. In some embodiments, the MPC control system or the AI system can provide constant monitoring and control. Once a model with sufficient confidence is found, the MPC control system or the AI system can begin to take control. When confidence drops, the PID control retakes control in some embodiments. In some embodiments, the use of models and MPC allows the system to choose the optimal control sequence for a variety of conditions and bring the system under control as quickly as possible. In some embodiments, a hybrid control system using elements of PID (e.g., PID with PRAC) and MPC controls one or more pieces of building equipment or building systems.

Connected equipment is subject to tampering in a variety of ways. For example, a malfeasor can change a setpoint to directly drive the system or equipment to an unfavorable state and/or can change measurements, thereby tricking the control system into believing it is never reaching the setpoint and driving it to an unfavorable state. In some embodiments, systems and methods use adaptive AI to determine that a control system is being tampered with by creating a model of the system that can identify when the chosen setpoint would drive the state to an unfavorable condition or identify when measurements are not tracking to expected behavior for a given setpoint and control action.

Detecting equipment degradation is generally done by reviewing sensor measurements and using a model to check for changes in the behavior of equipment. These models can be white, black, or grey, but focus on the equipment themselves and require necessary sensors. In some embodiments, systems and methods use a flow for detecting degradation with minimal sensor interaction by using a model of the control as a proxy for the equipment condition.

In some embodiments, an adaptive AI model is generated for the response of the system and disturbance. This model can be used to generate an optimal control action for a prediction of the system and disturbance along with extra inputs such as outdoor air conditions and time of day in some embodiments. By tracking this model over time as the model is refit, the predicted control action for the same conditions can be analyzed by an additional model that looks for increases in necessary control to flag potential degradation. For example, if after a year a device must run 10% harder (e.g., larger stroke position, fan speed, energy usage, etc.) to meet the same setpoint under the same conditions, the model would flag a system degradation to be investigated. In some embodiments, systems and methods sweep the control action for its range of control conditions and feed the N dimensional surfaces into a model trained to output a level of degradation, where N is an integer.

### Building HVAC Systems

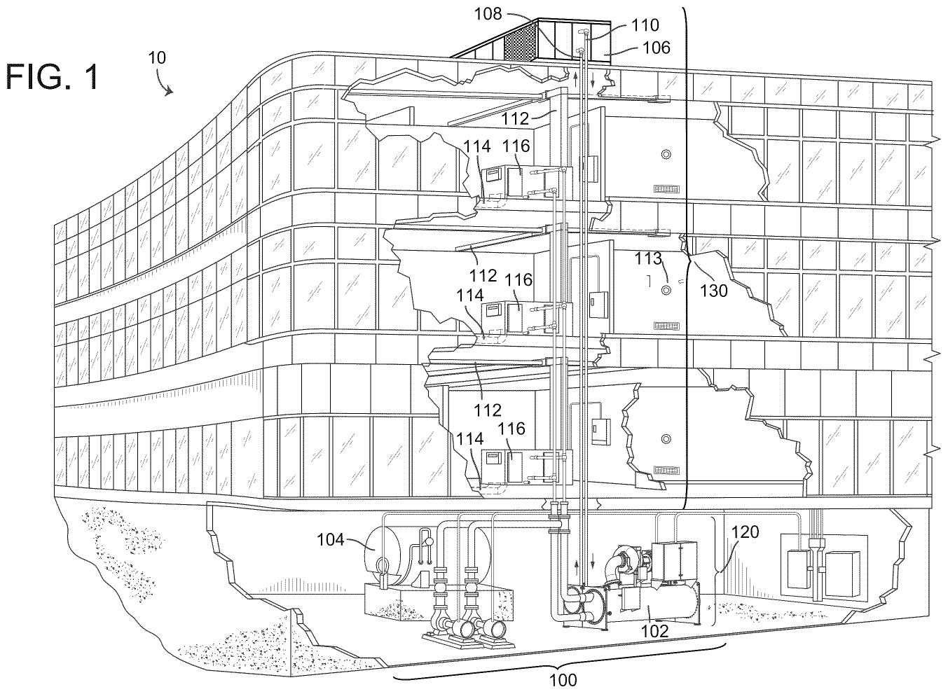

Referring to FIG. 1, a perspective view of a building 10 is shown. Building 10 is served by a building management system (BMS). A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. Although certain embodiments of systems and methods are described with respect to an HVAC system, the systems and methods can be applied to other applications including but not limited to other systems in a BMS. Further, the systems and methods can be applied on a component by component basis in a BMS, to larger systems in a BMS, or on a zone by zone basis.

The BMS that serves building 10 includes an HVAC system 100. HVAC system 100 can include a plurality of HVAC devices (e.g., heaters, chillers, air handling units (AHU), pumps, fans, thermal energy storage, controllers, thermostats 113, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

HVAC system 100 thereby provides heating and cooling to the building 10. The building 10 also includes other sources of heat transfer that the indoor air temperature in the building 10. The building mass (e.g., walls, floors, furniture) influences the indoor air temperature in building 10 by storing or transferring heat (e.g., if the indoor air temperature is less than the temperature of the building mass, heat transfers from the building mass to the indoor air). People, electronic devices, other appliances, etc. (“heat load”) also contribute heat to the building 10 through body heat, electrical resistance, etc. Additionally, the outside air temperature impacts the temperature in the building 10 by providing heat to or drawing heat from the building 10.

### HVAC System and Model

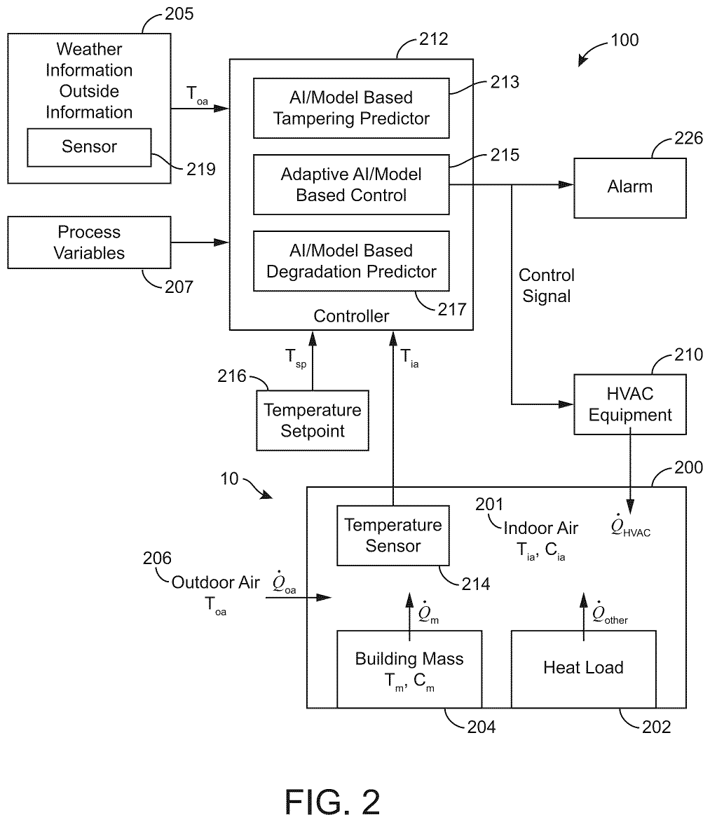

Referring now to FIG. 2, a block diagram of the HVAC system 100 for use with building 10 is shown, according to an exemplary embodiment. More particularly, FIG. 2 illustrates the variety of heat transfers that affect the indoor air temperature Tᵢₐ of the indoor air 201 in zone 200 of building 10. Zone 200 is a room, floor, area, etc. of building 10. Zone 200 can be an entire building or residence in some embodiments. In general, the primary goal of the HVAC system 100 is to maintain the indoor air temperature Tᵢₐ in the zone 200 at or around a desired temperature to facilitate the comfort of occupants of the zone 200 or to meet other needs of the zone 200.

As shown in FIG. 2, the indoor air temperature Tᵢₐ of the zone 200 has a thermal capacitance Cᵢₐ. The indoor air temperature Tᵢₐ is affected by a variety of heat transfers \dot{Q} into the zone 200, as described in detail below. It should be understood that although all heat transfers \dot{Q} are shown in FIG. 2 as directed into the zone 200, the value of one or more of the heat transfers \dot{Q} may be negative, such that heat flows out of the zone 200. Zone 200 can be an entire building or residence in some embodiments.

The heat load 202 contributes other heat transfer \dot{Q}ₒₜₕₑᵣ to the zone 200. The heat load 202 includes the heat added to the zone by occupants (e.g., people, animals) that give off body heat in the zone 200. The heat load 202 also includes computers, lighting, and other electronic devices in the zone 200 that generate heat through electrical resistance, as well as solar irradiance.

The building mass 204 contributes building mass heat transfer \dot{Q}ₘ to the zone 200. The building mass 204 includes the physical structures in the building, such as walls, floors, ceilings, furniture, etc., all of which can absorb or give off heat. The building mass 204 has a temperature Tₘ and a lumped mass thermal capacitance Cₘ. The resistance of the building mass 204 to exchange heat with the indoor air 201 (e.g., due to insulation, thickness/layers of materials, etc.) may be characterized as mass thermal resistance Rmi.

The outdoor air 206 contributes outside air heat transfer \dot{Q}ₒₐ to the zone 200. The outdoor air 206 is the air outside of the building 10 with outdoor air temperature Tₒₐ. The outdoor air temperature Tₒₐ fluctuates with the weather and climate. Barriers between the outdoor air 206 and the indoor air 201 (e.g., walls, closed windows, insulation) create an outdoor-indoor thermal resistance Rₒᵢ to heat exchange between the outdoor air 206 and the indoor air 201.

The HVAC system 100 also contributes heat to the zone 200, denoted as \dot{Q}HVAC. The HVAC system 100 includes HVAC equipment 210, controller 212, an indoor air temperature sensor 219 and an outdoor air temperature sensor 219. The HVAC equipment 210 may include the waterside system 120 and airside system 130 of FIG. 1, or other suitable equipment for controllably supplying heating and/or cooling to the zone 200. In general, HVAC equipment 210 is controlled by a controller 212 to provide heating (e.g., positive value of \dot{Q}_{HVAC}) or cooling (e.g., a negative value of \dot{Q}_{HVAC}) to the zone 200. HVAC equipment 210 can be a single component (e.g., VAV unit, pump, valve, damper, fan, etc.) or a larger system. Controller 212 can be a system controller or a controller for one or more components (e.g., a VAV unit controller).

Commands from the controller 212 may be implemented by the actuators of HVAC equipment 210. Actuators may include any device or mechanism for affecting the operations of the HVAC equipment 210. For example, actuators may include relays that turn the HVAC equipment 210 on or off, dampers to direct and/or modulate airflow (e.g., within the airside system 130), valves to direct and/or modulate fluid flow (e.g., within the waterside system 120), motor drives that affect the speed of pumps or compressors (e.g., of the chiller 102), and/or other suitable devices configured to receive signals (e.g., from the controller 212) and affect the operations of equipment (e.g., HVAC equipment 210) based on information of the received signals.

The indoor air temperature sensor 214 is located in the zone 200, measures the indoor air temperature Tᵢₐ, and provides the measurement of Tᵢₐ to the controller 212. The outdoor air temperature sensor 219 is located outside of the building 10, measures the outdoor air temperature Tₒₐ, and provides the measurement of Tₒₐ to the controller 212. A user interface, sensor, controller 212, computer system, or other device (e.g., thermostat 113 in FIG. 1) can provide temperature setpoint 216 in some embodiments. Measured values (e.g., temperatures, air quality, humidity, and occupancy, etc.) and setpoint 216 can be provided by other sensors, servers, interfaces, etc. (e.g., remote or local).

The controller 212 receives the temperature measurements Tₒₐ and Tᵢₐ and generates a control signal for the HVAC equipment 210, and transmits the control signal to the HVAC equipment 210. The temperature measurements Tₒₐ and Tᵢₐ can be provided by sensor 219 and sensor 214 or a computer system in communication with controller 212. The operation of the controller 212 can be as described in U.S. patent application Ser. No. 16/513,054 filed Jul. 16, 2019, and U.S. Pat. No. 9,835,349. In general, the controller 212 receives weather information and other information (e.g., seasonal information, occupancy information, scheduling information, etc.) 205 and process variable information 207, a temperature setpoint 216 or Tₛₚ from a source and provides a control signal or command for controlling HVAC equipment 210.

The control signal can be provided by an AI/model based control module 215. In some embodiments, the AI/model based control module 215 is a hybrid adaptive AI MPC and PID control system. In some embodiments, the AI/model based control module 215 is configured to provide constant monitoring and control. In some embodiments, the AI/model based control module 215 is configured to use a PID control system control to provide the control signal until sufficient confidence is achieved in MPC control. Once a model with sufficient confidence is found, the MPC control system takes control. When confidence drops, the AI/model based control module 215 is configured to have the PID control system retake control in some embodiments. The confidence can be determined by comparing model outputs to PID control system outputs, predictions of the MPC system to future actual measurements, and/or model outputs to historical values for similar input criteria in some embodiments. Module 215 provides real time control in some embodiments.

Controller 212 includes an AI/model based tampering prediction module 213. AI/model based tampering prediction module 213 is configured to determine that a control system is being tampered with by creating a model of the system that can identify when the chosen setpoint would drive the state to an unfavorable condition or identify when measurements are not tracking to expected behavior for a given setpoint and control action. AI/model based tampering prediction module 213 can provide an alarm 226 via an alarm interface or institute a control action in response to a detected tampering. The alarm interface can be part of a computer, smartphone, display, speaker, a message interface, or other interface.

Controller 22 includes an AI/model based degradation prediction module 217. AI/model based degradation prediction module 217 is configured to use an adaptive AI model to generate a response of the system and disturbance. This model can be used to generate an optimal control action for a prediction of the system and disturbance along with extra inputs such as outdoor air conditions and time of day in some embodiments. By tracking this model over time as the model is refit, the AI/model based degradation prediction module 217 to flag potential degradation. AI/model based degradation module 217 can provide alarm 226 via the alarm interface or institute a control action in response to a detected degradation.

In some embodiments, the control signal provided to the HVAC equipment 210 by the controller 212 indicates a temperature setpoint Tₛₚ for the zone 200 or indicates a control action for the HVAC equipment (e.g., a command). The command can be produced by AI/model based control module 215.

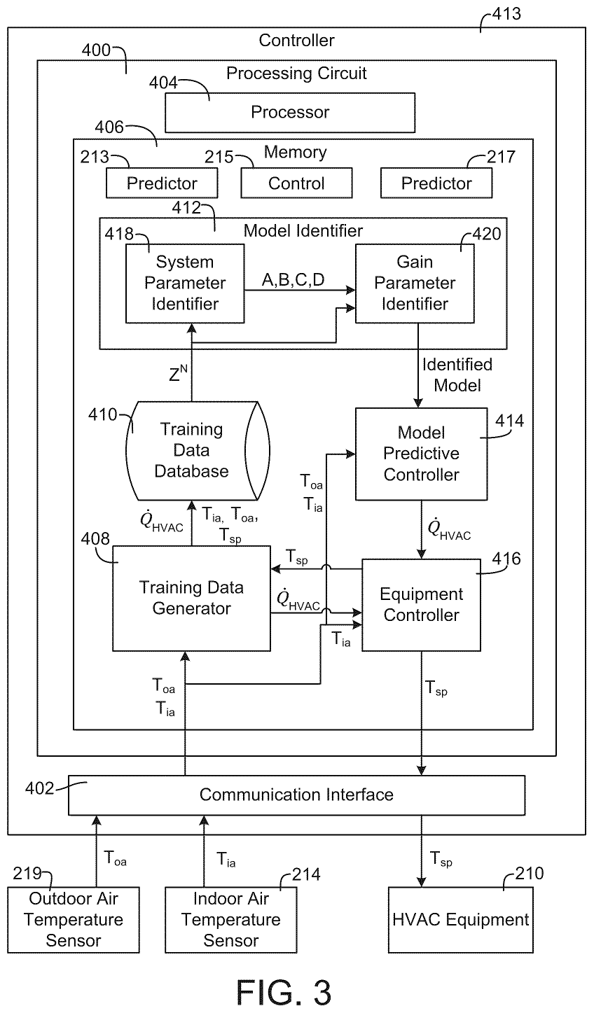

In some embodiments, AI/model based control module 215 provides a setpoint for equipment 210. Other types of setpoints can be provided. To determine the temperature setpoint Tₛₚ, the controller 212 assumes that the relationship between the indoor air temperature Tᵢₐ and the temperature setpoint Tₛₚ follows a proportional-integral control law with saturation, represented as:

$${\dot{Q}}_{HVAC , j} = {K}_{p , j} {ε}_{sp} + {K}_{I , j} {\int }_{0}^{t} {ε}_{sp} ( s ) ds \qquad ( Eq . A )$$

$${ε}_{sp} = {T}_{sp , j} - {T}_{ia} \qquad ( Eq . B )$$

where j∈{clg, hlg} is the index that is used to denote either heating or cooling mode. Different parameters K_{p,j} and K_{l,j} are needed for the heating and cooling mode. Moreover, the heating and cooling load is constrained to the following set: \dot{Q}_{HVAC,j}∈[0, \dot{Q}_{clg,max}] for cooling mode (j=clg) and \dot{Q}_{HVAC,j}∈[−\dot{Q}_{htg,max}, 0] for heating mode (j=htg). As discussed in detail below with reference to FIG. 3, the controller 212 uses this model in generating a control signal for the HVAC equipment 210.

As used herein, the term ‘variable’ refers to an item/quantity capable of varying in value over time or with respect to change in some other variable. A “value” as used herein is an instance of that variable at a particular time. A value may be measured or predicted. For example, the temperature setpoint Tₛₚ or a command is a variable that changes over time, while Tₛₚ(3) is a value that denotes the setpoint at time step 3 (e.g., 68 degrees Fahrenheit). The term “predicted value” as used herein describes a quantity for a particular time step that may vary as a function of one or more parameters.

In some embodiments, controller 212 is implemented as a field-programmable gate array, an application-specific integrated circuit, hardware, a software executing processor, a group of processing components, other suitable electronic processing components or state machines. Instructions for the processing circuit are stored in a non-transitory medium such as memory in some embodiments.

The memory may be one or more devices (e.g., RAM, ROM, Flash memory, hard disk storage) for storing data and/or computer code for completing and/or facilitating the various processes described herein. The memory may be or include non-transient volatile memory, non-volatile memory, and non-transitory computer storage media. Memory may include database components, object code components, script components, or any other type of information structure for supporting the various activities and information structures described herein. The memory may be communicably coupled to a processor and include computer code or instructions for executing one or more processes described herein (e.g., processes associated with modules 213, 215, and 217). The processor may be coupled to a network (e.g., BACnet connection, WAN connection, LAN connection, WLAN connection, etc.).

Controller for HVAC Equipment with System Identification

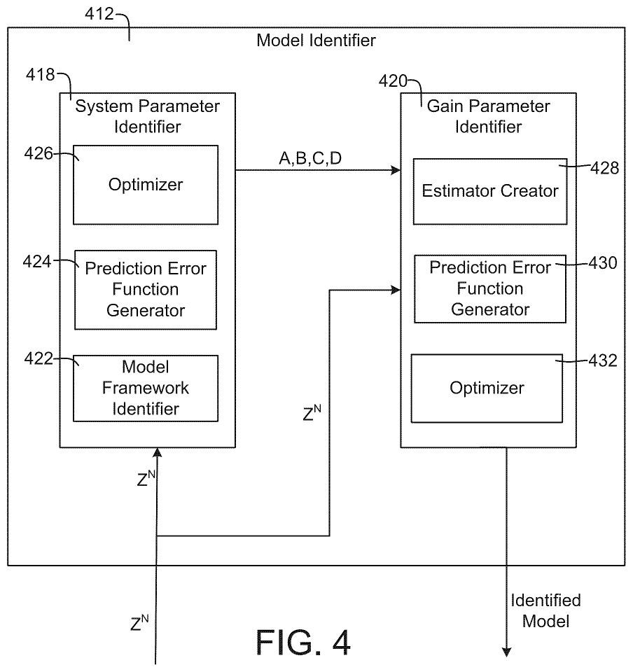

Referring now to FIG. 3, an embodiment of the controller 212 (FIG. 2) is controller 413, according to an exemplary embodiment. The controller 413 includes a processing circuit 400 and a communication interface 402 which can be configured to perform the operations of one or more of modules 213, 215, and 217. The communication interface 402 is structured to facilitate the exchange of communications (e.g., data, control signals) between the processing circuit 400 and other components of the HVAC system 100. As shown in FIG. 4, the communication interface 402 facilitates communication between the processing circuit 400 and the outdoor air temperature sensor 219 and the indoor air temperature sensor 219 to all temperature measurements Tₒₐ and Tᵢₐ to be received by the processing circuit 400. The communication interface 402 also facilitates communication between the processing circuit 400 and the HVAC equipment 210 that allows a control signal (indicated as temperature setpoint Tₛₚ) to be transmitted from the processing circuit 400 to the HVAC equipment 210.

The processing circuit 400 is structured to carry out the functions of the controller described herein. The processing circuit 400 includes a processor 404 and a memory 406. The processor 404 may be implemented as a general-purpose processor, an application-specific integrated circuit, one or more field programmable gate arrays, a digital signal processor, a group of processing components, or other suitable electronic processing components. The memory 406, described in detail below, includes one or more memory devices (e.g., RAM, ROM, NVRAM, Flash Memory, hard disk storage) that store data and/or computer code for facilitating at least some of the processes described herein. For example, the memory 406 stores programming logic that, when executed by the processor 404, controls the operation of the controller 413. More particularly, the memory 406 includes a training data generator 408, a training data database 410, a model identifier 412, a model predictive controller 414, and an equipment controller 416. The various generators, databases, identifiers, controllers, etc. of memory 406 may be implemented as any combination of hardware components and machine-readable media included with memory 406.

The equipment controller 416 is configured to generate a temperature setpoint Tₛₚ that serves as a control signal for the HVAC equipment 210 or a command the serves as a control signal for HVAC equipment 210. The equipment controller 416 receives inputs of the indoor air temperature Tᵢₐ from the indoor air temperature sensor 219 via the communication interface 402 and \dot{Q}_{HVAC} from the model predictive controller 414 (during normal operation) and the training data generator 408 (during a training data generation phase described in detail below). The equipment controller uses Tᵢₐ and \dot{Q}_{HVAC} to generate Tₛₚ by solving Eq. A and Eq. B above for Tₛₚ. The equipment controller 416 then provides the control signal or set point Tₛₚ to the HVAC equipment 210 via the communication interface 402.

The model predictive controller 414 determines \dot{Q}_{HVAC} based on an identified model and the temperature measurements Tᵢₐ. Tₒₐ, and provides \dot{Q}_{HVAC} to the equipment controller 416. The model predictive controller 414 follows a model predictive control (MPC) approach. The model predictive controller 414 can be part of AI/model based tampering prediction module 213. The MPC approach involves predicting future system states based on a model of the system, and using those predictions to determine the controllable input to the system (here, \dot{Q}_{HVAC}) that bests achieve a control goal (e.g., to maintain the indoor air temperature near a desired temperature). A more accurate model allows the MPC to provide better control based on more accurate predictions. Because the physical phenomena that define the behavior of the system (i.e., of the indoor air 201 in the building 10) are complex, nonlinear, and/or poorly understood, a perfect model derived from first-principles is generally unachievable or unworkable. Thus, the model predictive controller 414 uses a model identified through a system identification process facilitated by the training data generator 408, the training data database 410, and the model identifier 412, described in detail below.

System identification (e.g., training), as facilitated by the training data generator 408, the training data database 410, and the model identifier 412, is a process of constructing mathematical models of dynamic systems. System identification provides a suitable alternative to first-principles-derived models when first principles models are unavailable or too complex for online MPC computations. System identification captures the important and relevant system dynamics based on actual input/output data (training data) of the system, in particular by determining model parameters particular to a building or zone to tune the model to the behavior of the building/zone. As described in detail below, the training data generator 408, the training data database 410, and the model identifier 412 each contribute to system identification by the controller 413. System identification (e.g., training) can be performed to fit parameters for various types of models including state-space models, autoregressive models, and neural network models. System identification (e.g., training) may include generating an objective function (e.g., loss function) that is related to the goodness of fit of the model over a set of training data. The system identification or training process then adjusts the parameters of the model towards to result in lower loss over the training data.

The training data generator 408 is configured to generate training data by providing an excitation signal to the system. That is, the training data generator provides various \dot{Q}_{HVAC} values to the equipment controller 416 for a number N of time steps k, and receives the measured output response of the indoor air temperature Tᵢₐ at each time step k from the air temperature sensor 219. The various \dot{Q}_{HVAC} values may be chosen by the training data generator 408 to explore the system dynamics as much as possible (e.g., across a full range of possible \dot{Q}_{HVAC} values, different patterns of \dot{Q}_{HVAC} values, etc.).

The equipment controller 416 receives the various \dot{Q}_{HVAC} values and generates various control inputs Tₛₚ in response. The temperature setpoint Tₛₚ for each time step k is provided to the HVAC equipment 210, which operates accordingly to heat or cool the zone 200 (i.e., to influence Tᵢₐ). The temperature setpoints Tₛₚ may also be provided to the training data generator 408 to be included in the training data. The training data generator receives an updated measurement of the indoor air temperature Tᵢₐ for each time step k and may also receive the outdoor air temperature Tₒₐ for each time step k. The training data generator 408 thereby causes the states, inputs, and outputs of the system to vary across the time steps k and generates data corresponding to the inputs and outputs. AI/model based tampering prediction module 213, AI/model based tampering prediction module 213, AI/model based control module 215, and AI/model based degradation prediction module 217 can be provided as part of equipment controller 416 in some embodiments.

The inputs and outputs generated by the training data generator 408 are provided to the training data database 410. More particularly, in the nomenclature of the model of Eq. E and Eq. F above, the training data generator 408 provides inputs Tₛₚ and Tₒₐ and outputs \dot{Q}_{HVAC} and Tᵢₐ for each time step k to the training data database 410.

The training data database 410 stores the inputs and outputs for each time step k provided by the training data generator 408. Each input and output is tagged with a time step identifier, so that data for the same time step can be associated together. The training data database 410 thereby collects and stores input and output data for each time step k, k 0, . . . , N, or, more specifically, Tₛₚ(k), Tₒₐ(k), Tᵢₐ(k), and \dot{Q}_{HVAC}(k), for k, k 0, . . . , N. This data is grouped together in the training data database 410 in a set of training data Z^{N}. In the notation of Eq. G and Eq. H, Z^{N}=[y(1), u(1), y(2), u(2), . . . , y(N), u(N)].

In some embodiments, the training data is refined using a saturation detection and removal process. System and methods for saturation detection and removal suitable for use to refine the training data Z^{N} are described in U.S. patent application Ser. No. 15/900,459, filed Feb. 20, 2018, incorporated by reference herein in its entirety. For example, as described in detail therein, the training data may be filtered by determining whether the operating capacity is in a non-transient region for a threshold amount of a time period upon determining that an error for the building zone exists for the time period, and in response to a determination that the operating capacity is in the non-transient region for at least the threshold amount of the time period, indicating the time period as a saturation period. Data from the saturation period can then be removed from the training data.

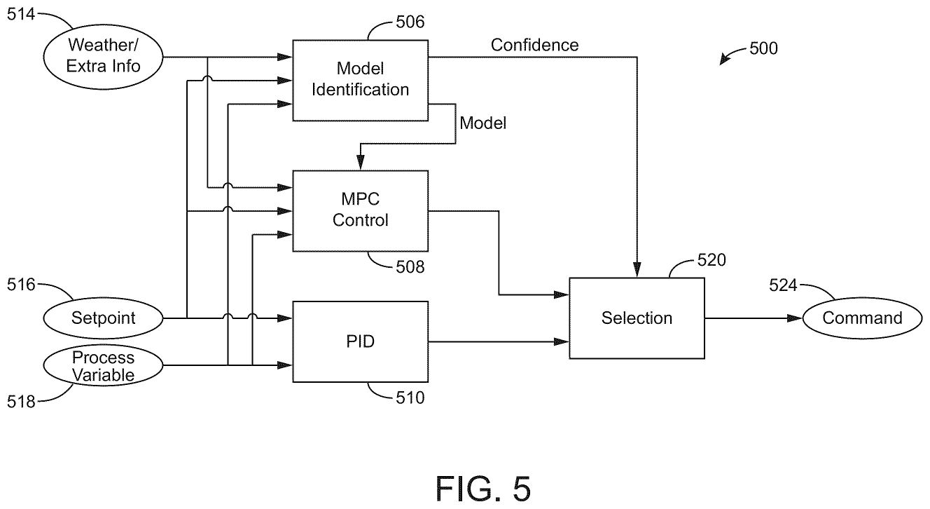

The model identifier 412 accesses the training data database 410 to retrieve the training data Z^{N} and uses the training data Z^{N} to identify a model of the system. The model identifier 412 includes a system parameter identifier 418 and a gain parameter identifier 420. As shown in detail in FIG. 5 and discussed in detail with reference thereto, the system parameter identifier 418 carries out a first step of system identification, namely identifying the model parameters, while the gain parameter identifier 420 carries out the second step, namely determining a Kalman gain estimator. The model parameters and the Kalman gain estimator are included in an identified model of the system, and that model is provided to the model predictive controller 414. The model predictive controller can thus facilitate the control of the HVAC equipment 210 as described above.

More detailed descriptions of model identifiers and model identification processes are described in U.S. application Ser. No. 16/513,054, filed Jul. 16, 2019, incorporated herein by reference in its entirety.

With reference to FIG. 5, controller 212 (FIG. 2) (e.g., module 215) can be configured to include a system 500. System 500 can be module 215 and includes an input for receiving weather and other information 514, an input for receiving a setpoint 516, and an input for receiving a process variable 518. In some embodiments, system 500 includes a model identification module 506, an MPC control module 508, a selection module 520, and a PID control module 510. The setpoint can be a flow setpoint, a temperature setpoint, air quality setpoint, humidity setpoint or combinations thereof in some embodiments.

PID control module receives setpoint 516 and process variable 518 and uses PID techniques to provide a setpoint or command to selection module 520. Selection module 520 selects the setpoint or command from module 510 when a confidence factor is below a threshold for output as command 524. PID control module 510 can use proportional, integral and derivative based control. In some embodiments, PID control module 510 provides a non-PID control scheme with or without feedback. In some embodiments, PID control module 510 is a proportional controller, a proportional integral controller, a derivative controller or other feedback controller.

MPC control module 508 receives setpoint 516, information 514, and process variable 518 and uses model techniques to provide a setpoint or command to selection module 520. Selection module 520 selects the setpoint or command from module 508 when a confidence factor is above a threshold for output as command 524. MPC control module 508 uses model based control to provide the set point or command. The model for MPC control module 508 can be provided by or indicated by model identification module 506. In some embodiments, the model for MPC control module 508 is an AI module that is not an MPC model.

Model identification module 506 can select a model based upon setpoint 516, information 514, and process variable 518 in response to information (e.g., an input for receiving weather and other information 514, and input for receiving a setpoint 516, and an input for receiving a process variable 518). The information can include but is not limited to set points, equipment type, weather, season, occupancy, zone type, building type, time of day, energy constraints, time of day, cost constraints, quality of air constraints, etc. The model can be a zone model, an equipment model, a building model, an environment model, etc. The use of information 514 allows MPC control module 508 to provide predictive, proactive, and/or responsive control. The model can be used to react to the information 514 and disturbances more quickly than PID control module 510 in some embodiments. Model identification module 506 can include a library of models correlated with variables associated with the information discussed above.

In some embodiments, model identification module 506 generates a model. In some embodiments, model identification module 506 generates an MPC model or AI model in response to the system information and disturbances. The MPC model or AI model is generated using AI in some embodiments. This model can be used to generate a prediction of the system information, disturbance and control action based on the current state and extra inputs such as outdoor air conditions and time of day. The MPC model can be selected using system or model identification parameters from model identifier 412. The MPC or AI model may have the form of a state-space model, an autoregressive model, and/or a neural network model. In some embodiments, the model may include a number of sub models. Sub models can be averaged or otherwise combined to produce a single output for the model and/or the confidence. For example, the model may combine a neural network model with a state-space model or an autoregressive model.

In some embodiments, the model (e.g., the MPC or AI model) is used by the MPC control 508 on-line (e.g., during the calculation of the control output and/or actuator commands). For example, a control step may include receiving the weather information 514, the setpoint 516, and the process variable 518, using the model to predict the output for various sequences of control actions, and optimizing the output (e.g., based on an objective function). In some embodiments, the model is used by the MPC control 508 to generate (e.g., develop, train, etc.) rules (e.g., functions, strategies, etc.) that can be executed on-line. The model is used off-line to generate the rules for the MPC control 508 and indirectly determine the control output and/or actuator commands. For example, the model can be used to generate a set of training data that includes the inputs (e.g., the weather information 514, the setpoint 516, and the process variable 518), state history, and the respective command. A function can be trained (e.g., via regression, stochastic gradient descent, etc.) based on the training data to approximate the optimal results.

In some embodiments, the model is similar to a Thevenin equivalent. The model can include model coefficients that can be changed to adjust the model. The model can be configured to respond to operational differences when a valve is turned on, a season change occurs, a time of day change, a staging occurs (e.g., staging of chillers or compressors), and other criteria to which a PID control system may have a sluggish response. In some embodiments, the model includes constraints to prevent out-of-bounds states or too aggressive changes. In some embodiments, AI is used to allow the model to respond to the changes due to time of year or time of day. The AI can learn the disturbances and appropriate responses associated with occupancy, time of day and time of year in some embodiments. In some embodiments, models are trained using variables (e.g., setpoints, time of day, occupancy, and time of year) to provide the appropriate control signal (e.g., a setpoint for damper position). The AI learns the relationship between the variables and the proper control signal. Various AI techniques can be used such as R squared factors, horizon prediction, etc.

Model identification module 506 can provide the confidence factor in response to the setpoint 516, information 514, and process variable 518. In some embodiments, model identification module 506 can provide the confidence factor in response to comparisons of the outputs of MPC control module 508 and PID control module 510. MPC control module 508 and PID control module 510 are run in parallel and responsive to the input for receiving weather and other information 514, the input for receiving a setpoint 516, and the input for receiving a process variable 518. The information received by PID control module 510 is a subset of the information received by MPC control module 508 in some embodiments. In some embodiments, the command 524 is chosen by a technique where larger a discrepancy between the of MPC control module 508 and PID control module 510 results in a bias toward choosing the output of PID control module 510 in some embodiments. In some embodiments, model identification module 506 can provide the confidence factor in response to comparisons of the outputs of MPC control module 508 and PID control module 510, the setpoint 516, information 514, and process variable 518. In some embodiments, a manual selection of a model is provided via a user interface.

In some embodiments, selection module 520 is configured to have PID control module 510 provide the command 524 until sufficient confidence is achieved in the output from MPC control module 508. Once sufficient confidence is achieved in MPC control module 508, selection module 502 chooses the output of MPC control module 508 for command 524. When confidence drops, selection module 520 is configured to have the PID control module 510 provide command 524 in some embodiments. The confidence can be determined by comparing outputs of module 508 or module 510 or to historical values for similar input criteria in some embodiments. In some embodiments, a manual override of the selection is provided via a user interface.

The MPC control 508 may produce a sequence of control actions that can be implemented by the HVAC equipment 210. For example, the MPC control 508 may execute at a rate that is slower than when commands are sent to the HVAC equipment 210. Selection 520 may store (e.g., buffer, etc.) the commands and output them at the proper time (e.g., as indicated by the MPC control 508).

In some embodiments, the command is transmitted (e.g., sent, signaled, etc.) to actuators of the HVAC equipment 210. Actuators may include any suitable devices configured to receive signals (e.g., from the controller 212) and affect the operations of equipment (e.g., HVAC equipment 210) based on information of the received signals. For example, actuators may include relays, motor drives (e.g., of fans, pumps, compressors, etc.), dampers (e.g., and their motors), valves (e.g., and their motors), etc. The command may be provided either directly to an actuator or the command may be further processed (e.g., used as input to additional calculations, control algorithms, etc.) before the result is transmitted to the actuator.

In some embodiments, upper and lower bounds for the command 524 are utilized to assess the confidence. In some embodiments, a confidence factor is determined by training the model on a first set of data and then applying a second set of data and determining how well the model was fit and identified. In some embodiments, the predicted horizon using the model is compared to the actual horizon to determine quality. In some embodiments, confidence is determined for both model identification and model fit.

In some embodiments, the confidence can be associated with a particular range of input criteria (e.g., input variables, model inputs, etc.) where input criteria outside of the range is an indication of lower confidence. A model may predict well for input that is near input found in the training data (e.g., of training data database 410) and therefore the output of MPC control 508 would produce suitable commands 524 for the HVAC equipment 210. The model identification 506 may output high confidence for similar input. A model may predict poorly for input that is not near many input found in the training data (e.g., of training data database 410) and therefore the output of MPC control 508 may produce unsuitable commands 524 for the HVAC equipment 210 indicative of poor confidence which and necessitating the selection of PID 510 output. The model identification 506 may output high confidence for similar input.

In some embodiments, the confidence may be based on a region of inputs that satisfy a distance criterion with the current input. The MPC control 508, for example, is predictive; thus if in the controller or a disturbance is expected to drive the system out of a region of where the model identification 506 indicates a good fit confidence may be reduced.

The confidence in the model can be calculated during training (e.g., if the confidence is low, the MPC control 508 would not be selected until retraining is performed). Additionally or alternatively, the confidence can be calculated online (e.g., based on any of the inputs to the MPC control 508). In some embodiments, the model is used to generate the rules (e.g., function, strategy, etc.) that govern the input/output relationship of the MPC control 508; the confidence in the model may still be calculated on-line or during training. For example, an average confidence for all the training data used to generate the rules can be found off-line. As another example, the rules can additionally include the confidence in the model and/or the amount of training data in a region of the current inputs (and the confidence can be output on-line as the control output is calculated).

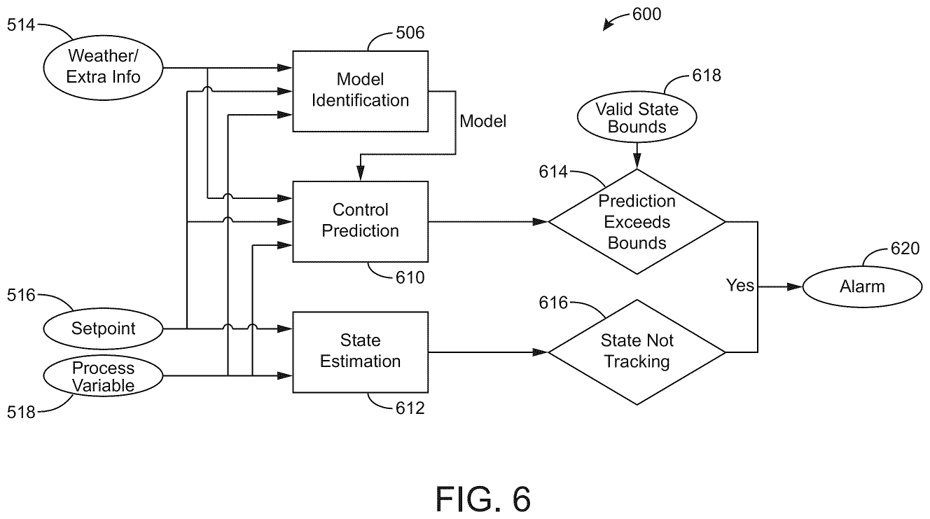

With reference to FIG. 6, controller 212 (e.g., module 213 (FIG. 2)) can be configured to include a system 600. System 600 can be module 213 and includes an input for receiving weather and other information 514, an input for receiving a setpoint 516, and an input for receiving a process variable 518. In some embodiments, system 600 includes model identification module 506, a control prediction module 610, a state estimation module 612, a state decision module 616, a prediction decision module, a bound module 618 and an output for an alarm 620.

Control prediction module 610 is configured to use a model of the system that can identify when the chosen setpoint would drive the state to an unfavorable condition or identify when measurements are not tracking to expected behavior for a given setpoint and control action. The model can be provided by model identification module 506 discussed above. State estimation module 612 provides an estimation of the system state to state decision module 616 (e.g., using a Kalman filter, observer, or other type of estimation algorithm). The estimation of system state is provided in response to information (e.g., the input for receiving weather and other information 514, the input for receiving a setpoint 516, and the input for receiving a process variable 518). If the estimated state does not track to (e.g., diverges from) known states, decision module 616 provides an alarm 620 via an alarm interface or institutes a control action in response to a detected tampering. The estimated state can be considered diverging when measurements are not tracking expected behavior or for a given setpoint and control action in some embodiments. The alarm interface can be part of a computer, smartphone, display, speaker, a message interface, or other interface.

Control prediction module 610 provides a prediction based upon the current state and in response to information (e.g., an input for receiving weather and other information 514, an input for receiving a setpoint 516, and an input for receiving a process variable 518). The prediction is provided to prediction decision module 614 and compared in prediction decision module 614 to valid state boundaries stored in bound module 618. If the prediction is outside of boundaries, decision module 614 provides alarm 226 via the alarm interface or institutes a control action in response to a detected tampering. In some embodiments, the prediction is a prediction of state and the boundaries in module 618 represent desirable states.

In some embodiments, the valid state bounds 618 may be determined by a model (e.g., averaging model, splines, neural network model, etc.) trained with historical state data. For example, the historical state data can be bucketed by a day of the week and for each day a function (e.g., a spline) that best fits the data can be determined. Additionally, based on the error between the function and the data a standard error (e.g., a number of standard deviations of the error) can be determined and used as thresholds a distance away from the function that is still considered acceptable. In some embodiments, the valid state bounds 618 may depend on the weather or other external factors known or determined to affect the typical operating states of the building.

In some embodiments, the alarm or response to a detection may depend on how the detection criterion is satisfied. For example, if the prediction exceeds the valid state bounds, but the state is tracking well, tampering with the setpoint may be indicated and a first action taken (e.g., resetting the setpoint). If the state is not tracking well, but the prediction is still within the bounds, model mismatch may be indicated and the controller may initiate another fitting procedure. If the prediction exceeds the bounds and the state is not tracking well, feedback tampering may be indicated and a third action (e.g., removing the controller from the network may be taken).

Alarm 620 represents tampering with the controller 212 which can make one or more occupants uncomfortable, waste energy/money, cause malfunctions, cause equipment wear, cause loss of products and/or medical complications. For example, by a threat actor artificially providing incorrect setpoints and/or feedback variables to the controller without the knowledge of the operator. Advantageously, system 600 detects the tampering before significant deviations have occurred and bounds have been violated by using modules 614 and/or 610. In some embodiments, system 600 can also raise alarms with minimal configuration outside of setting bounds and with tolerance for false positives. In some embodiments, when detection occurs the controller can (e.g., after sending an alarm) remove itself from the external network (e.g., stop excepting remote inputs) and/or initialize a reset to prevent continued tampering.

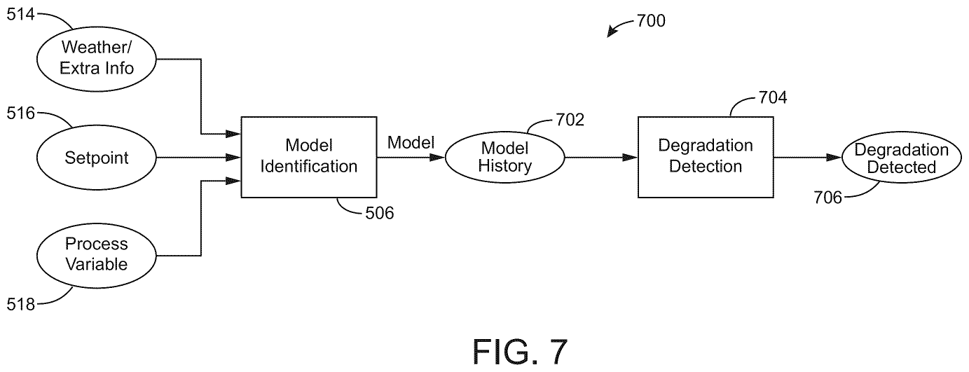

With reference to FIG. 7, controller 22 (e.g., module 217 (FIG. 2)) can be configured to include a system 700. System 700 can be module 217 and includes an input for receiving weather and other information 514, an input for receiving a setpoint 516, and an input for receiving a process variable 518. In some embodiments, system 600 includes model identification module 506, a model history module 702, a degradation detection module 704, and an output for a degradation detection 706.

Degradation detection module 704 may be configured to use an adaptive AI model from model identification module 506 to generate a response of the system and disturbance. This model can be used to generate an optimal control action for a prediction of the system and disturbance along with extra inputs such as outdoor air conditions and time of day in some embodiments. By tracking this model over time as the model is refit using model history module 702 which stores the models over time, the degradation detection module 704 provides a degradation detection 706 at an alarm interface. The degradation detection 706 is an indication of a potential degradation or is a control action in response to a detected degradation. In some embodiments, the degradation detection module 704 sweeps control actions for its range of control conditions and feeds N dimensional surfaces (e.g., representing control conditions) into a model trained to detect degradation.

In some embodiments, degradation is determined by using a load characteristic where changes to load characteristics indicate degradation. In some embodiments, load characteristics with respect to system performance are used to determine deterioration where the same system performance at different loads is an indication of system degradation. A gray box model can be used that characterizes load in some embodiments. In some embodiments, filter wear or clogging can be determined based upon temperature performance in a zone associated with the filter. In some embodiments, refrigerant leaking or clogging can be determined based upon temperature performance in a zone associated with the coil.

In some embodiments, the criterion for detection of degradation is based on the input to output relationship of the control process. For example, before degradation detection 704, the model identification 506 may be used by control prediction 610 or MPC control 508 to determine a command given the set of inputs (e.g., weather, setpoints, and process variables). The command for the same or similar inputs can be compared by degradation detection 704. If the comparison satisfies a detection criterion that may be indicative of a degradation of performance.

The detection criterion may include a number of tests individually or in combination. For example, the detection criterion may include breaking the multi-dimensional space of inputs to the controller into various regions. A probability density function for a commanded output determined for inputs in that region may be determined. At a later time, a hypothesis test (e.g., a t-test) can be used to determine if the statistics (e.g., average, standard deviation, etc.) of the density function have changed by a statistically significant amount. If the commanded output has increased on average (e.g., as determined by the hypothesis test), the HVAC equipment may be outputting more (e.g., cooling, heating, flow, etc.) for the same inputs and degradation is indicated. In some embodiments, detection may occur based on the number of regions (or the fraction of regions) for which the test (e.g., the t-test) is satisfied. For example, the criterion may specify that at least three regions should indicate a significant change in a statistic or at least twenty-five percent of the regions should indicate a significant change.

In some embodiments, an action is initiated responsive to the detection criterion being satisfied. For example, if the equipment is critical an alarm may be initiated. Additionally or alternatively, a notification may be sent (e.g., transmitted, communicated, etc.) to an operator of the equipment in the form of an automatically generated e-mail, text message, user interface popup window, etc. In some embodiments, maintenance actions may be initiated. For example, control parameters may be automatically adjusted by the controller to improve performance and/or a maintenance request ticket can be automatically generated to initiate a service call.

Performing system identification can identify a predictive model that captures important system dynamics (e.g., thermal dynamics) and produces accurate multi-step predictions of system evolution into the future in some embodiments. However, accuracy of the predictive model may decrease with time due to various factors such as, for example, changes in disturbances or changes in physical properties of the system. As full system identification processes can be computationally expensive, adaptive online SI can improve accuracy of the predictive model without necessitating a full SI process be performed to generate a new predictive model if accuracy of the predictive model drifts from preferred values in some embodiments.

Modeling system dynamics (e.g., building energy dynamics, heating, ventilation, or air conditioning (HVAC) dynamics, etc.) through system identification can include steps of identifying a deterministic heat disturbance model, identifying system dynamics and a scale factor of deterministic heat disturbance, and identifying a Kalman gain and a stochastic heat disturbance prediction model in some embodiments. By performing said steps, a predictive model can be generated to model various system dynamics in some embodiments. Advantageously, modeling of the system dynamics need not be limited to building thermal models. The above steps (or some portion of them) can be applied to model other dynamics in buildings such as, for example, relative humidity, particulate matter 2.5 (PM2.5), carbon dioxide, etc. However, system identification alone may be performed in batch form such that each step is completely remodeled using only new data gathered during a system identification experiment in some embodiments. This may result in old data that is rich in content and/or previous predictive models being ignored and not utilized.

To improve upon system identification, adaptive SI utilizes old models and/or old data coupled with new data collected online to generate new and more accurate predictive models in some embodiments. In particular, adaptive SI can include two adaptive SI frameworks including light online SI and intensive online SI in some embodiments. Light online SI can be utilized to adjust a predictive model to account for changes in heat disturbances on a frequent basis in some embodiments. Heat disturbances may change frequently due to changes in solar effects, occupant dynamics, and other factors that change regularly. As physical properties of buildings may not change frequently, light online SI can keep models some system dynamical models constant and only remodel a Kalman gain and heat disturbance models to improve accuracy of the predictive model in some embodiments. In this way, light online SI can be performed regularly to keep the predictive model accurate without unnecessary processing requirements for full SI in some embodiments.

Intensive online SI can be performed if light online SI fails to generate new/updated predictive models with acceptable multi-step prediction accuracy needed for MPC and/or other applications in some embodiments. If light online SI fails to generate acceptable predictive models, this may indicate that physical properties of the system have changed. As such, intensive online SI can further re-identify system dynamics to capture changes in the physical properties. Advantageously, as intensive online SI may be more computationally expensive than light online SI, intensive online SI may only need to be performed occasionally (e.g., seasonally, quarterly, etc.) as compared to light online SI which can be performed more frequently (e.g., daily, weekly, monthly, etc.).

Systems, methods, and experimental results of performing adaptive online system identification (SI) are shown in U.S. patent application Ser. No. 16/513,054, according to some embodiments. It should be appreciated that adaptive SI can be referred to interchangeably with adaptive online system identification for ease of explanation. The application of model predictive control (MPC) technology in buildings has the potential for creating significant energy and cost savings. MPC can rely on availability of a model that can capture crucial process dynamics and can produce accurate multi-step predictions of process evolution into the future. Modeling energy and HVAC systems through first-principles models that describe detailed physical properties can be challenging and may result in models that are not suited for MPC online computations. Therefore, system identification can serve as a suitable alternative and can result in models that are suited for MPC online optimization. However, accuracy of the identified model may decrease with time due to several factors such as, for example, significant changes in disturbances or changes in physical properties of the system. As such, adaptive SI can be utilized to update the identified models online if/when accuracy of the model decreases.

In some embodiments, modeling building energy and HVAC systems can include the following three steps: identification of a deterministic heat disturbance model, identification of system dynamics and a scale factor for deterministic heat disturbance, and identification of a Kalman filter and a stochastic heat disturbance prediction model. It should be appreciated that said three step process is not limited to building thermal models. The three step process (or a portion thereof) can be used in modeling various dynamics in buildings such as, for example, relative humidity, particulate matter 2.5 (PM2.5), and carbon dioxide (CO₂). The modeling and system identification can be done in a batch form such that for each time identification is desired, all three steps are remodeled and only new data is used in the modeling. However, batch strategy may not be effective as previous model information is not utilized in training a new model.

The concept of adaptive models can refer to usage of old models coupled with new data collected online in creating new and more accurate models in some embodiments. In some embodiments, two adaptive SI frameworks for buildings models are presented. Each of the adaptive SI frameworks may start with an adaptive heat disturbance modeling step that utilizes an old model coupled with data collected online in order to generate accurate heat disturbance training data. The adaptive heat disturbance modeling method can utilize online data, a system dynamical model, online heat disturbance profiles from old stochastic and deterministic prediction models, and Kalman filter errors in order to generate accurate heat disturbance training data. Utilizing the Kalman filter errors and the system dynamical model can be useful to learn true shapes and variations in heat disturbances.

A first adaptive system identification method can be referred to as light online system identification (light online SI). In light online SI, data collected online along with adaptive heat disturbance training data can be used in order to train a new deterministic heat disturbance model, a new scale factor for deterministic heat disturbance, a new stochastic heat disturbance prediction model, and a new Kalman filter gain. Light online SI can provide various processing improvements for a computer system performing system identification and/or MPC. In some embodiments, physical properties of buildings do not change on a regular basis. For example, physical properties of buildings may change every four to six months. Physical properties may change due to various factors such as, for example, occupants opening windows thereby leading to less resistance between indoor and air outdoor air (i.e., a change in a physical property), construction in a building, etc. As compared to physical properties, heat disturbances may change on a regular basis as solar effects and occupant dynamics can change frequently. Therefore, it may not be necessary to constantly re-identify all models/model parameters if old models perform poorly. In this way, light online SI can keep the old system dynamical model(s) and can remodel the Kalman filter gain and the heat disturbance models and components. As such, light online SI can provide processing improvements as fewer models/model parameters are re-identified regularly in some embodiments.

A second adaptive SI method can be referred to as intensive online system identification (intensive online SI). In intensive online SI, data collected online along with the adaptive heat disturbance training data can be used in order to re-identify all models in some embodiments. As such, intensive online SI may include re-identification of a deterministic heat disturbance model, re-identification of system dynamics, re-identification of a scale factor for deterministic heat disturbance, and re-identification of a Kalman filter and a stochastic heat disturbance prediction model. Intensive online SI can be used if light online SI fails to generate models with an acceptable multi-step prediction accuracy that may be needed for MPC applications. If light online SI fails to generate acceptable models, this may indicate that not only heat disturbance components have changed, but also that some physical properties of the system have changed. If physical properties of the system have changed, remodeling of the entire system may be needed. Adaptive heat disturbance training data can still be used in intensive online SI as the adaptive heat disturbance training may have a component that accounts for plant model mismatch. In addition, intensive online SI may be robust to any bias in the adaptive heat disturbance training data as intensive online SI can include re-identifying the system dynamics along with the scale factor for deterministic heat disturbance in the same step. In some embodiments, due to the fact that the intensive online SI can re-identify the system dynamical model, the training data used for intensive online SI should contain only data sections with sufficient system dynamics excitations. Therefore, a data selection process can be utilized in order to select sections of the training data that contain sufficient excitations of the system dynamics. Said data sections can be used as the training data in intensive online SI in some embodiments.

In some embodiments, a bucket of models can be used to ensure MPC utilizes a best available model. It may not always be the case that a most recently identified model is the most accurate predictive model of available models. However, the default models bucket can ensure that a most accurate available predictive model is used regardless of whether the most recently identified model is the most accurate available predictive model in some embodiments.

The online system identification data selection process can be applied on gathered data in order to extract useful data for intensive online SI in some embodiments. The data selection process performed in the example experiment removed weekend data when the HVAC system was turned off and no set-point changes occurred. Said weekend data may result in invalid data for intensive online SI. Further, the data selection process performed in the example experiment selected the remaining work days' data (i.e., Monday through Friday) as valuable data that contained sufficient HVAC excitations which is suitable for intensive online SI. Intensive online SI can obtain improved models if light online SI fails to satisfy a desired multi-step quality of predictions in some embodiments.

### Operational Flows

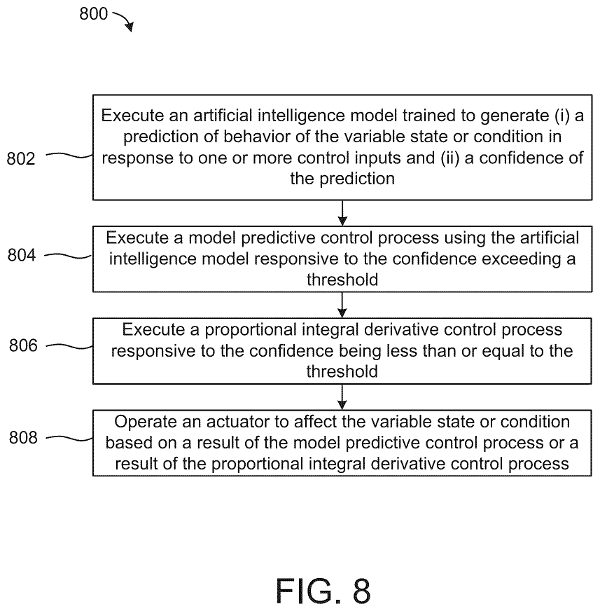

FIGS. 8-10 are flows of operations describing methods that the controller 212 may perform, for example, by AI/Model based tampering predictor 213, adaptive AI/Model based control 215, and/or AI/Model based degradation predictor 217.

FIG. 8 shows flow of operations 800 for providing predictive control (e.g., model predictive control) or PID control dependent on a selection based on the confidence of the model used by the predictive control algorithm. Flow 800, for example, may be performed by the adaptive AI/Model based control 215. In some embodiments, flow 800 includes executing an artificial intelligence model trained to generate a prediction of behavior of the variable state or condition in response to one or more control inputs and a confidence of the prediction in operation 802. The prediction of the variable state or condition can be used to improve control, for example, by using a model predictive control process. The confidence of the prediction will later be used to select between the model predictive control or a traditional control technique (e.g., PID control).

The confidence of the model may depend on the training data used to generate the model. For example, if the model is able to fit the training data well, then confidence may be high. In some embodiments, the confidence is a constant value for the model (e.g., the confidence will remain the same until the model is retrained (e.g., via adaptive model identification or training). In some embodiments, the confidence depends on the input to the model used to create the prediction. For example, confidence may be higher in regions were there was more training data used to create the model.

In some embodiments, flow 800 includes executing a model predictive control process using the artificial intelligence model responsive to the confidence exceeding a threshold in operation 804. In some situations (e.g., well fit training data, certain inputs, etc.), confidence in the model may be high and predictive control appropriate. The predictive control algorithm may be run and delivered as the control output. In some embodiments, the predictive control algorithm is run continuously, but only sent as the control output if confidence is high. The unused predictive control output may be displayed on an user interface or otherwise used to monitor the algorithm.

In some embodiments, flow 800 executes a proportional integral derivative control process responsive to the confidence being less than or equal to the threshold in operation 806. In some situations (e.g., poor training data, certain inputs outside of the typical range, etc.), confidence in the model may be low and predictive control inappropriate. The adaptive AI/Model based control 215 may select the PID control algorithm for output to the equipment. The PID control algorithm may be run and delivered as the control output. In some embodiments, the PID control algorithm is run continuously, but only sent as the control output if confidence is low. The unused PID output (e.g., when confidence is high) may be displayed on an user interface or otherwise used to monitor the algorithm's performance.

In some embodiments, flow 800 includes operating an actuator to affect the variable state or condition based on a result of the model predictive control process or a result of the proportional integral derivative control process in operation 808. Actuators may include any device or mechanism for affecting the operations of the HVAC equipment 210. For example, actuators may include relays that turn the HVAC equipment 210 on or off, dampers to direct and/or modulate air flow (e.g., within the airside system 130), valves to direct and/or modulate fluid flow (e.g., within the waterside system 120), motor drives that affect the speed of pumps or compressors (e.g., of the chiller 102), and/or other suitable devices configured to receive signals (e.g., from the controller 212) and affect the operations of equipment (e.g., HVAC equipment 210) based on information of the received signals. The result of the model predictive control process or the result of the proportional integral derivative control process may be provided either directly to the actuator or the result may be further processed (e.g., used as input to additional calculations, control algorithms, etc.) before being communicated to the actuator. It is noted that an actuator may affect a controlled state or condition directly and/or indirectly. For example, adjusting a cooling valve may directly change the amount of water flowing through the valve (e.g., directly affecting a flow state) and change the temperature in the zone (e.g., indirectly affecting the temperature state by changing the flow).

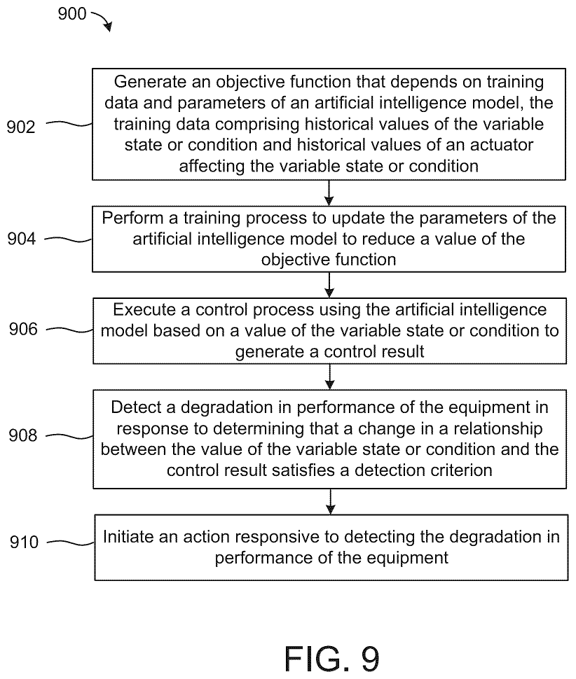

FIG. 9 shows flow of operations 900 for detecting degradation of the equipment (e.g., controlled by the adaptive AI/Model based control 215). Flow 900, for example, may be performed by the AI/Model based degradation predictor 217. In some embodiments, flow 900 includes generating an objective function that depends on training data and parameters of an artificial intelligence model, the training data comprising historical values of the variable state or condition and historical values of an actuator affecting the variable state or condition in operation 902. The objective function can be used to determine appropriate parameters for the artificial intelligence model (e.g., parameters that will cause good control, a good model fit, etc.). For example, the objective function may be the squared error between the model fit given inputs in the training data to the respective outputs in the training data. Other objective functions can also be used alternatively or in combination. For example, a 1-norm of the error can be used (e.g., instead of squared error (2-norm)).

In some embodiments, flow 900 includes performing a training process to update the parameters of the artificial intelligence model to reduce a value of the objective function in operation 904. An optimization process may be performed to drive the parameters towards a lower cost function. For example, linear least squares provides an non-iterative solution to the least squares problem or if a neural network model is used for prediction, stochastic gradient descent may be performed to obtain suitable model coefficients.

Flow 900 may include execute a control process using the artificial intelligence model based on a value of the variable state or condition to generate a control result in operation 906. A control output provided may depend on inputs to the control algorithm (e.g., feedback variables, weather data, measured loads, etc.).

In some embodiments, flow 900 includes detecting a degradation in performance of the equipment in response to determining that a change in a relationship between the value of the variable state or condition and the control result satisfies a detection criterion in operation 908. For example, the detection criterion may include breaking the multi-dimensional space of inputs to the controller into various regions. A probability density function for a commanded output determined for inputs in that region may be determined. At a later time, a hypothesis test (e.g., a t-test) can be used to determine if the statistics (e.g., average, standard deviation, etc.) of the density function have changed by a statistically significant amount. If the commanded output has increased on average (e.g., as determined by the hypothesis test), the HVAC equipment may be outputting more (e.g., cooling, heating, flow, etc.) for the same inputs and degradation is indicated. In some embodiments, detection may occur based on the number of regions (or the fraction of regions) for which the test (e.g., the t-test) is satisfied. For example, the criterion may specify that at least three regions should indicate a significant change in a statistic or at least twenty-five percent of the regions should indicate a significant change.

In some embodiments, flow 900 includes initiating an action responsive to detecting the degradation in performance of the equipment in operation 910. For example, if the equipment is critical an alarm may be initiated. Additionally or alternatively, a notification may be sent (e.g., transmitted, communicated, etc.) to an operator of the equipment in the form of an automatically generated e-mail, text message, user interface popup window, etc. In some embodiments, maintenance actions may be initiated. For example, control parameters may be automatically adjusted by the controller to improve performance and/or a maintenance request ticket can be automatically generated to initiate a service call.

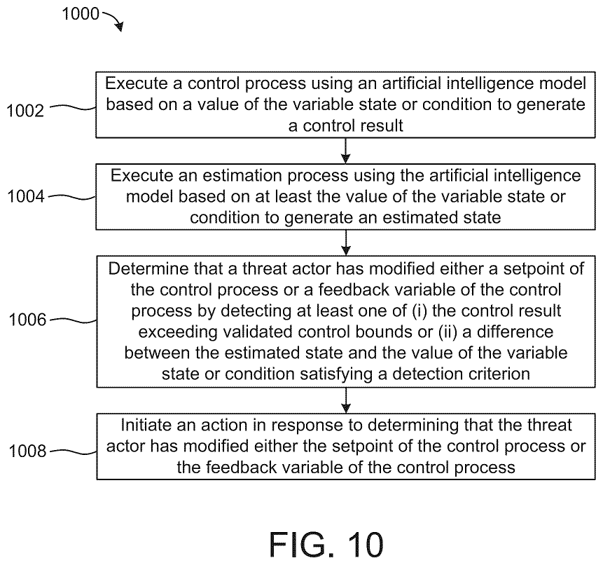

FIG. 10 shows flow of operations 1000 for detecting tampering with the controller 212 (e.g., by a threat actor attempting to cause discomfort, malfunction, etc.) Flow 1000, for example, may be performed by AI/model based tampering prediction module 213. In some embodiments, flow 1000 includes executing a control process using an artificial intelligence model based on a value of the variable state or condition to generate a control result in operation 1002. The control result may be generated by any suitable control algorithm (e.g., model predictive control, PID control, the selective control of the adaptive AI/Model based control 215, etc.).

Flow 1000 may include executing an estimation process using the artificial intelligence model based on at least the value of the variable state or condition to generate an estimated state in operation 1004. For example, the inputs along with the model provided by model identification 506 may be used to determine an estimated output. In some embodiments, a Kalman filter (or an extended Kalman filter or another nonlinear variant) may be used to estimate the output in the presence of various disturbance types.

In some embodiments, flow 1000 includes determining that a threat actor has modified either a setpoint of the control process or a feedback variable of the control process by detecting at least one of (i) the control result exceeding validated control bounds or (ii) a difference between the estimated state and the value of the variable state or condition satisfying a detection criterion in operation 1006. In is noted that it is possible to cause the estimated state to diverge from the setpoint by making minute, but persistent modifications to the process variable (e.g., adding a small constant offset). For example, if the state is controlled by a PID controller, a persistent offset will cause the PID to continue to increase (or decrease) the commanded action until a limit is reached. In detecting a difference between the estimated state and the value of the variable state or condition it may be just as important to detect small, but persistent deviations. Detection of small deviations can be performed using, for example, and integrated error, detecting a number of consecutive errors that are on one side of zero (e.g., negative or positive), or any suitable control chart technique that cable of detecting small offsets.

In some embodiments, flow 1000 includes initiating an action in response to determining that the threat actor has modified either the setpoint of the control process or the feedback variable of the control process in operation 1008. For example, in response to a positive detection, the controller can (e.g., after sending an alarm) remove itself from the external network (e.g., stop excepting remote inputs) and/or initialize a reset to prevent continued tampering.

### Configuration of Exemplary Embodiments

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, calculation steps, processing steps, comparison steps, and decision steps.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations. The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

What is claimed is:

1. A controller for equipment that operates to affect a variable state or condition of a building, the controller comprising:
one or more processors; and
one or more non-transitory computer-readable media storing instructions that, when executed by the one or more processors, cause the one or more processors to perform operations comprising:
executing an artificial intelligence model trained to generate (i) a prediction of behavior of the variable state or condition in response to one or more control inputs and (ii) a confidence of the prediction;
executing a model predictive control process using the artificial intelligence model responsive to the confidence exceeding a threshold;
executing a proportional integral derivative control process responsive to the confidence being less than or equal to the threshold; and
operating an actuator to affect the variable state or condition based on a result of the model predictive control process or a result of the proportional integral derivative control process.

2. The controller of claim 1, wherein the confidence of the prediction depends on a current value of the variable state or condition.

3. The controller of claim 2, wherein the confidence of the prediction depends on a plurality of values of the variable state or condition that satisfy a distance criterion to the current value.

4. The controller of claim 1, wherein the artificial intelligence model comprises at least one of:
a state-space model;
a neural network model; or
an autoregressive model.

5. The controller of claim 1, wherein executing the artificial intelligence model comprises:
generating a first prediction of the behavior and a first confidence of the first prediction using a first submodel;
generating a second prediction of the behavior and a second confidence of the second prediction using a second submodel;
outputting the first prediction responsive to the first confidence exceeding the second confidence; and
outputting the second prediction responsive to the first confidence being less than or equal to the second confidence.

6. The controller of claim 5, wherein the first submodel comprises a neural network model and the second submodel comprises an autoregressive model or a state-space model.

7. The controller of claim 1, wherein the result of the model predictive control process comprises a sequence of control actions to implement over a time period.

8. The controller of claim 1, the operations further comprising:
generating an objective function that depends on historical behavior of the variable state or condition, historical values of the actuator, and parameters of the artificial intelligence model; and
performing a training process to update the parameters of the artificial intelligence model to reduce a value of the objective function.

9. A controller for equipment that operates to affect a variable state or condition of a building, the controller comprising:
one or more processors; and
one or more non-transitory computer-readable media storing instructions that, when executed by the one or more processors, cause the one or more processors to perform operations comprising:
generating an objective function that depends on training data and parameters of an artificial intelligence model, the training data comprising historical values of the variable state or condition and historical values of an actuator affecting the variable state or condition;
performing a training process to update the parameters of the artificial intelligence model to reduce a value of the objective function;
executing a control process using the artificial intelligence model based on a value of the variable state or condition to generate a control result;
detecting a degradation in performance of the equipment in response to determining that a change in a relationship between the value of the variable state or condition and the control result satisfies a detection criterion; and
initiating an action responsive to detecting the degradation in performance of the equipment.

10. The controller of claim 9, wherein the artificial intelligence model comprises at least one of:
a state-space model;
a neural network model; or
an autoregressive model.

11. The controller of claim 9, wherein detecting the degradation in performance of the equipment comprises:
generating a plurality of regions of the variable state or condition;
calculating a first average result based on a first set of results corresponding to a first set of values of the variable state or condition within a region of the plurality of regions, the first set of values of the variable state collected during a first time period before updating the parameters;
calculating a second average result based on a second set of results corresponding to a second set of values of the variable state or condition within the region of the plurality of regions, the second set of values of the variable state collected during a second time period after updating the parameters; and
calculating a difference of the first average result and the second average result.

12. The controller of claim 11, wherein detecting the degradation in performance of the equipment further comprises:
calculating a first standard deviation of the first set of results and a second standard deviation the second set of results; and
determining if the difference is greater than a function of the second standard deviation and the first standard deviation.

13. The controller of claim 12, wherein detecting the degradation in performance of the equipment further comprises determining that the detection criterion is satisfied in response to a fraction of the plurality of regions for which the difference is greater than the function exceeds a fractional threshold.

14. The controller of claim 9, wherein the action comprises:
sending a notification;
executing a proportional integral derivative control process; or
initiating a maintenance action.

15. A controller for equipment that operates to affect a variable state or condition of a building, the controller comprising:
a circuit configured to:
execute a control process using an artificial intelligence model based on a value of the variable state or condition to generate a control result;
execute an estimation process using the artificial intelligence model based on at least the value of the variable state or condition to generate an estimated state;
determine that a threat actor has modified either a setpoint of the control process or a feedback variable of the control process by detecting at least one of (i) the control result exceeding validated control bounds or (ii) a difference between the estimated state and the value of the variable state or condition satisfying a detection criterion; and
initiate an action in response to determining that the threat actor has modified either the setpoint of the control process or the feedback variable of the control process.

16. The controller of claim 15, wherein the action comprises:
sending a notification;
initiating a reset procedure; or
disconnecting the controller from an external network.

17. The controller of claim 15, wherein the estimation process comprises a Kalman filter.

18. The controller of claim 15, wherein the validated control bounds are determined based at least on data comprising historical control results and historical values of the variable state or condition.

19. The controller of claim 18, wherein the validated control bounds are determined based additionally on historical weather data and current weather data.

20. The controller of claim 15, wherein the action is further based on a model fit metric of the artificial intelligence model using recent values of the variable state or condition and recent values of the control result.
